(19) United States
(12) Patent Application Publication
(10) Pub. No.: US 2026/0362412 A1
(43) Pub. Date: Nov. 12, 2026

(54) TRANSMISSION RECEPTION POINT ADAPTATION

(71) Applicant: Nokia Technologies Oy, Espoo (FI)

(72) Inventors: Matha DEGHEL, Paris (FR); Naizheng ZHENG, Beijing (CN)

(73) Assignee: Nokia Technologies Oy, Espoo (FI)

(21) Appl. No.: 19/100,253

(22) PCT Filed: Aug. 12, 2022
(86) PCT No.: PCT/CN2022/112201

§ 371 Date: Jan. 31, 2025

(51) Int. Cl. H04W 72/11; H04L 5/00

(52) U.S. Cl. CPC H04W 72/11; H04L 5/0091

(57) ABSTRACT

Embodiments of the present disclosure relate to transmission reception point (TRP) adaptation for network energy efficiency. A terminal device receives, from a network device, a configuration for con-~figuring one or more timers corresponding to one or more TRPs for the terminal device. The terminal device starts or restarts a timer of the one or more timers based on one or more transmissions or receptions associated with a corresponding TRP of the one or more TPRs. The terminal device determines that the TRP is muted based on expiry of the timer. In this way, with expiry of the timer corresponding to the TRP, the terminal device may determine or assume status of the TRP without a need to receive indications from the network, thereby enabling the dynamic TRP adaptation without increasing downlink control overhead.

### FIELD

Various example embodiments relate to the field of telecommunication and in particular, to methods, devices, apparatuses and a computer readable storage medium for transmission reception point (TRP) adaptation.

### BACKGROUND

In communication area, a radio access network usually consumes the largest part of total energy consumption in the network and adaptation techniques of transmissions and/or receptions in time, frequency, spatial, and power domains are important for energy savings.

In Rel-18, it is further agreed to utilize spatial domain techniques, for example, dynamic TRP adaptation, for a purpose of network energy savings. Thus enabling of the dynamic TRP adaptation needs to be further studied.

### SUMMARY

In general, example embodiments of the present disclosure provide a solution for enabling of the dynamic TRP adaptation for network energy efficiency.

In a first aspect, there is provided a terminal device. The terminal device comprises at least one processor and at least one memory storing instructions that, when executed by the at least one processor, cause the terminal device at least to: receive, from a network device, a configuration for configuring one or more timers corresponding to one or more transmission reception points, TRPs, for the terminal device; start or restart a timer of the one or more timers based on one or more transmissions or receptions associated with a corresponding TRP of the one or more TPRs; and determine that the TRP is muted based on expiry of the timer.

In a second aspect, there is provided a network device. The network device comprises at least one processor; and at least one memory storing instructions that, when executed by the at least one processor, cause the network device at least to: determine, for a terminal device, a configuration for configuring one or more timers corresponding to one or more transmission reception points, TRPs, for the terminal device, a timer of the one or more timers being configured to start or restart based on one or more transmissions or receptions associated with a corresponding TRP of the one or more TPRs, and expiry of the timer indicating that the TRP is muted; and transmit the configuration to the terminal device.

In a third aspect, there is provided a method. The method comprises receiving, at a terminal device and from a network device, a configuration for configuring one or more timers corresponding to one or more transmission reception points, TRPs, for the terminal device; starting or restarting a timer of the one or more timers based on one or more transmissions or receptions associated with a corresponding TRP of the one or more TPRs; and determining that the TRP is muted based on expiry of the timer.

In a fourth aspect, there is provided a method. The method comprises determining, at a network device and for a terminal device, a configuration for configuring one or more timers corresponding to one or more transmission reception points, TRPs, for the terminal device, a timer of the one or more timers being configured to start or restart based on one or more transmissions or receptions associated with a corresponding TRP of the one or more TPRs, and expiry of the timer indicating that the TRP is muted; and transmitting the configuration to the terminal device.

In a fifth aspect, there is provided an apparatus comprising: means for receiving, at a terminal device and from a network device, a configuration for configuring one or more timers corresponding to one or more transmission reception points, TRPs, for the terminal device; means for starting or restarting a timer of the one or more timers based on one or more transmissions or receptions associated with a corresponding TRP of the one or more TPRs; and means for determining that the TRP is muted based on expiry of the timer.

In a sixth aspect, there is provided an apparatus comprising: means for determining, for a terminal device, a configuration for configuring one or more timers corresponding to one or more transmission reception points, TRPs, for the terminal device, a timer of the one or more timers being configured to start or restart based on one or more transmissions or receptions associated with a corresponding TRP of the one or more TPRs, and expiry of the timer indicating that the TRP is muted; and means for transmitting the configuration to the terminal device.

In a seventh aspect, there is provided a non-transitory computer readable medium comprising program instructions for causing an apparatus to perform at least the method according to any one of the above third to fourth aspect.

In an eighth aspect, there is provided a computer program comprising instructions, which, when executed by an apparatus, cause the apparatus at least to: receive, from a network device, a configuration for configuring one or more timers corresponding to one or more transmission reception points, TRPs, for the terminal device; start or restart a timer of the one or more timers based on one or more transmissions or receptions associated with a corresponding TRP of the one or more TPRs; and determine that the TRP is muted based on expiry of the timer.

In a ninth aspect, there is provided a computer program comprising instructions, which, when executed by an apparatus, cause the apparatus at least to: determine, for a terminal device, a configuration for configuring one or more timers corresponding to one or more transmission reception points, TRPs, for the terminal device, a timer of the one or more timers being configured to start or restart based on one or more transmissions or receptions associated with a corresponding TRP of the one or more TPRs, and expiry of the timer indicating that the TRP is muted; and transmit the configuration to the terminal device.

In a tenth aspect, there is provided a terminal device comprising: receiving circuitry configured to receive, from a network device, a configuration for configuring one or more timers corresponding to one or more transmission reception points, TRPs, for the terminal device; starting circuitry configured to start or restart a timer of the one or more timers based on one or more transmissions or receptions associated with a corresponding TRP of the one or more TPRs; and determining circuitry configured to determine that the TRP is muted based on expiry of the timer.

In an eleventh aspect, there is provided a network device comprising: determining circuitry configured to determine, for a terminal device, a configuration for configuring one or more timers corresponding to one or more transmission reception points, TRPs, for the terminal device, a timer of the one or more timers being configured to start or restart based on one or more transmissions or receptions associated with a corresponding TRP of the one or more TPRs, and expiry of the timer indicating that the TRP is muted; and transmitting circuitry configured to transmit the configuration to the terminal device.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which embodiments of the present disclosure may be implemented;

FIG. 2 illustrates an example of a process for enabling of the dynamic TRP adaptation according to some embodiments of the present disclosure;

FIG. 3 illustrates another example of a process for enabling of the dynamic TRP adaptation according to some embodiments of the present disclosure;

FIG. 4 illustrates a flowchart of a method implemented at a terminal device according to some embodiments of the present disclosure;

FIG. 5 illustrates a flowchart of a method implemented at a network device according to some embodiments of the present disclosure;

FIG. 6 illustrates a simplified block diagram of an apparatus that is suitable for implementing embodiments of the present disclosure; and

FIG. 7 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As used herein, the term “TRP” refers to a transmission reception point having an antenna array (with one or more antenna elements) at the network side located at a specific geographical location, which may be used for transmitting and receiving signals to/from the terminal device. In embodiment of the present disclosure, a TRP may refer to Macro Cell, micro cell, an RRH, a relay, a femto node, a pico node, etc. Although some embodiments of the present disclosure are described with reference to two TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

As mentioned above, the enabling of the dynamic TRP adaptation needs to be further studied. Specifically, when one or more TRPs for a terminal device are dynamically muted/deactivated/disabled and/or unmuted/(re)activated/enabled, the terminal device may need to operate accordingly with the muted or unmuted TRPs for network savings. However, currently there is no such mechanism proposed for this purpose.

According to embodiments of the present disclosure, there is providing a solution for enabling of the dynamic TRP adaptation. In this solution, a terminal device receives, from a network device, a configuration for configuring one or more timers corresponding to one or more TRPs for the terminal device. The terminal device starts or restarts a timer of the one or more timers based on one or more transmissions or receptions associated with a corresponding TRP of the one or more TPRs. The terminal device determines that the TRP is muted based on expiry of the timer.

In this way, with expiry of the timer corresponding to the TRP, the terminal device may assume or treat the TRP as muted without a need to receive indications from the network, thereby the enabling of the dynamic TRP adaptation without increasing downlink control overhead. Principle and embodiments of the present disclosure will be described in detail below with reference to the accompanying drawings. However, it is to be noted that these embodiments are illustrated as examples and not intended to limit scope of the present application in any way.

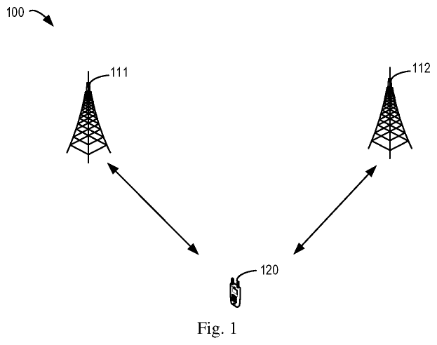

Reference is first made to FIG. 1, which illustrates an example communication system 100 in which embodiments of the present disclosure may be implemented. As illustrated in FIG. 1, the system 100 includes two network devices, such as network device 111 and network device 112. The network devices 111 and 112 may each have one respective group of antenna ports. In other words, the network devices 111 and 112 may be associated with or function as two respective TRPs, and thus sometimes they can be also referred to as TRP 111 and TRP 112 in the present disclosure.

The network devices 111 and 112 may each operate using different or same frequency bands in both DL and UL. In communication systems, “UL” refers to a communication link in a direction from a terminal device to a network device, and “DL” refers to a communication link in a direction from the network device to the terminal device.

The system 100 also includes one or more terminal devices, such as a terminal device 120. The terminal device 120 is capable of connecting, for example wirelessly, and communicating in an UL and DL with either or both of the network devices 111 and 112 depending on location of the terminal device in the cells of the network devices 111 and 112. The terminal device 120 may be configured to be communicated with the network via one or more TRPs, for example two TRPs. The two TRPs may be located within the same cell (intra-cell TRP) or within different cells (inter-cell TRP).

It is to be understood that in FIG. 1, the number of network devices and terminal devices is only for the purpose of illustration without suggesting any limitations. The system 100 may include any suitable number of network devices and terminal devices adapted for implementing embodiments of the present disclosure.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

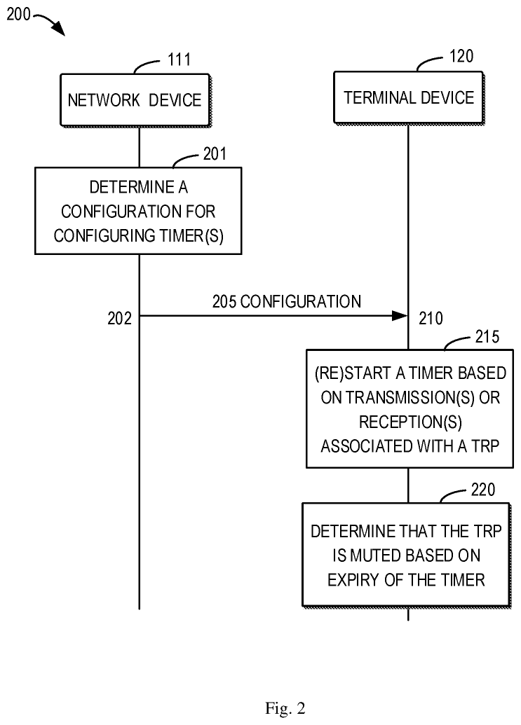

Reference is now made to FIG. 2, which shows an example of a process 200 for enabling of the dynamic TRP adaptation according to an embodiment of the present disclosure. For the purpose of discussion, the process 200 will be described with reference to FIG. 1. The network device 111 and the terminal device 120 may be involved in the process 200 for the purpose of illustration.

In the process 200, a network device (e.g., network device 111 not operating as a TRP) determines 201 a configuration 205 for the terminal device 120. The configuration 205 is used for configuring one or more timers corresponding to one or more TRPs for the terminal device 120. Each timer may correspond, explicitly or implicitly, to a respective TRP for the terminal device 120.

In some embodiments, a timer may be associated with a TRP identifier for identifying or representing a TRP. The identifier may be an identity of a TRP, e.g., a TRP ID. Alternatively or in addition, the identifier may be a set of reference signals (RSs). Alternatively or in addition, the identifier may be a control resource set (CORESET) Pool Index. Alternatively or in addition, the identifier may be a physical cell index (PCI). Thus the timer may be configured per TRP, per RS set, per CORESET Pool Index or per PCI.

The network device transmits 202 the configuration 205 to the terminal device 120. The terminal device 120 receives 210 the configuration 205. Based on the configuration 205 and different conditions, the terminal device 120 may determine whether to start, restart (if the timer is running), or stop the one or more timers.

As shown in FIG. 2, the terminal device 120 starts or restarts 215 a timer based on one or more transmissions or receptions associated with a corresponding TRP. In other words, the terminal device 120 may determine whether to (re)start a timer by considering transmission(s)/reception(s) associated with the TRP that corresponds to the timer.

In some embodiments, if the terminal device 120 receives, from the TRP, a physical downlink control channel (PDCCH) indicating a UL grant or a DL assignment, the terminal device 120 may start or restart the timer. In some embodiments, when the terminal device 120 receives a PDCCH sent on a CORESET belonging to a CORESET Pool Index corresponding to the timer, the terminal device 120 may start or restart the timer. In other words, if the terminal device 120 receives a PDCCH associated with a certain CORESET Pool Index, the terminal device 120 may determine or assume that a TRP represented or identified by the certain CORESET Pool Index is unmuted and the corresponding time should start for timekeeping.

Alternatively or additionally, when the terminal device 120 receives a PDCCH transmitted using a transmission configuration indicator (TCI) state and the TCI state comprises quasi co-location (QCL) information related to a reference signal (RS) belonging to a subset of RSs corresponding to the TRP, the terminal device 120 may start or restart the timer. In other words, if the terminal device 120 receives a PDCCH associated with a certain set of RSs, the terminal device 120 may assume that a TRP represented or identified by the certain set of RSs is unmuted. Thus the terminal device 120 may start or restart the corresponding timer for timekeeping.

In some embodiments, if the terminal device 120 receives, from the TRP, a physical downlink shared channel (PDSCH), the terminal device 120 may determine to start or restart the timer corresponding to the TRP. In some embodiments, when the terminal device 120 receives a medium access control packet data unit (MAC PDU) transmitted using a semi-persistent scheduling (SPS) PDSCH, and the SPS PDSCH is activated by a PDCCH sent on a CORESET belonging to a certain CORESET Pool Index corresponding to the TRP, the terminal device 120 may start or restart the timer.

Alternatively or in addition, when the terminal device 120 receives a MAC PDU transmitted using a SPS PDSCH related to a SPS configuration, and the SPS configuration is associated with a CORESET Pool Index or a PCI corresponding to the TRP, the terminal device 120 may start or restart the timer. Alternatively or in addition, when the terminal device 120 receives a MAC PDU transmitted using a SPS PDSCH, and the SPS PDSCH is transmitted using a TCI state comprising QCL information related to an RS belonging to a certain subset of RSs corresponding to the TRP, the terminal device 120 may start or restart the timer. The RS may be a source RS.

Alternatively or in addition, when the terminal device 120 receives a PDSCH scheduled by a PDCCH sent on a CORESET belonging to a certain CORESET Pool Index corresponding to the TRP, the terminal device 120 may start or restart the timer. Alternatively or in addition to the downlink receptions from the TRP, the terminal device 120 may start or restart the corresponding timer based on some uplink transmissions toward the TRP. In some embodiments, the terminal device 120 may start or restart the timer based on a transmission of a UL channel or signal, or a MAC PDU to the TRP. Examples of the UL channel or signal may comprise a PUSCH, a physical uplink control channel (PUCCH) or a sounding reference signal (SRS).

In some embodiments, when the terminal device 120 transmits, to the TRP, a UL channel or signal, or a MAC PDU using a resource associated with a CORESET Pool Index or a PCI corresponding to the TRP, the terminal device 120 may start or restart the timer for a round of timekeeping. Alternatively or in addition, when the terminal device 120 transmits a UL channel or signal using a TCI state that comprises QCL information related to an RS belonging to a subset of RSs corresponding to the TRP, the terminal device 120 may start or restart the timer. Alternatively or in addition, when the terminal device 120 transmits a UL channel or signal scheduled by a PDCCH sent on a CORESET belonging to a CORESET Pool Index corresponding to the TRP, the terminal device 120 may start or restart the timer.

In other cases, if the terminal device 120 does not receive or transmit any of the above channels or signals, the terminal device 120 may keep the timer running until the timer expires. In other words, the timer is configured for timekeeping a time period during which certain transmissions or receptions are not performed between the terminal device 120 and the TRP corresponding to the timer. In some embodiments, an expiration time period for the timer may be contained in the configuration 205 or may be configured otherwise by the network device. Alternatively or in addition, the terminal device 120 may determine the expiration time period for the timer.

When the timer expires, i.e., the terminal device 120 does not receive a PDCCH or a PDSCH from the TRP or transmit a PUSCH (or even a PUCCH/SRS) towards the TRP during the expiration time period in which the timer has been running, the terminal device 120 determines 220 that the TRP corresponding to the timer is muted. In other words, if the time period during which certain transmissions or receptions are not performed is longer than the expiration time period for the timer, the terminal device 120 may determine 220 that the corresponding TRP is muted. In this way, with expiry of the timer configured per TRP, the terminal device 120 may assume or treat a TRP as muted without a need of receiving DL indications from the network device 111. Thus the DL control overhead can be reduced.

In some embodiments, however, the terminal device 120 may still receive a DL indication from the network device 111 for muting or unmuting TRP(s). In this case, based on an indication of unmuting a TRP from the network device 111, the terminal device 120 may start or restart the timer corresponding to the TRP to start the timekeeping.

Alternatively or in addition, the terminal device 120 may start or restart the timer based on a radio resource control (RRC) reconfiguration from the network device 111. Alternatively or in addition, the terminal device 120 may start or restart the timer based on a time period after the expiry of the timer. In other words, the terminal device 120 may keep considering or treating the TRP as muted only for a certain time period. After this time period, the terminal device 120 may restart the timer for a new round of timekeeping.

In some embodiments, based on determining that the timer corresponding to the TRP expires, the terminal device 120 may perform acts accordingly, for example, for the purpose of energy saving.

In some embodiment, the terminal device 120 may stop the timer corresponding to the muted TRP without further maintenance for the timer. Alternatively or in addition, the terminal device 120 may stop monitoring a predetermined transmission of a DL channel or signal from the TRP. Alternatively or additionally, the terminal device 120 may stop monitoring all transmissions of DL channels or signals from the TRP. Alternatively or in addition, the terminal device 120 may stop transmitting a predetermined UL channel or signal or stopping transmitting all UL channels and signals towards the TRP. The terminal device 120 may determine or be indicated whether to continue monitoring some certain transmission from the muted TRP or transmitting some certain signals or channels toward the TRP.

Alternatively or in addition, the terminal device 120 may flush a hybrid automatic repeat request (HARQ) buffer corresponding to the TRP. Alternatively or in addition, the terminal device 120 may suspend or clear a grant, a resource, and/or a configuration corresponding to the TRP. Alternatively or in addition, based on determining that the TRP is muted, the terminal device 120 may assume that a synchronization signal block (SSB) is to be transmitted from the TRP. Alternatively, the terminal device 120 may assume that a SSB is not to be transmitted from the TRP. Alternatively or in addition, based on determining that the TRP is muted, the terminal device 120 may keep measuring channel state information (CSI) corresponding to a CSI configuration. Alternatively, the terminal device 120 may stop measuring a CSI corresponding to a CSI configuration.

Alternatively or in addition, the terminal device 120 may send, to the network device, an indication indicating that the TRP is considered as being muted by the terminal device 120. The terminal device 120 may send a report or a message via uplink control information (UCI) or a MAC CE on a PUCCH or a PUSCH to indicate that it considers a TRP as muted. The indication may indicate that the terminal device did not receive a PDCCH or PDSCH from the TRP or transmit a PUSCH (or even a PUCCH/SRS) towards the TRP for the whole period when the timer has been running. This indication may allow to further align the understanding between the terminal device 120 and the network device 111 on the assumption regarding TRP muting.

In some embodiments, a carrier aggregation is performed. The terminal device 120 may be configured with multiple cells and each cell may be configured with one or more TRPs which are allowed to be muted or disabled. A cell may be a serving cell or a non-serving cell. In this case, a timer corresponding to a TRP may be configured per cell or per cell group. In addition, the timer configured for the TRP in a cell may be configured for a bandwidth part (BWP) of the cell. Moreover, in an inter-cell multi-TRP scenario, a timer may be also configured per PCI.

In some embodiments, for a (serving) cell or BWP configured with multiple TRPs (e.g., through a CORESETPoolIndex configuration), when the timers corresponding to the multiple TRPs get expired, the terminal device 120 may determine or treat the multiple TRPs as muted and thus determine that the cell is muted or deactivated.

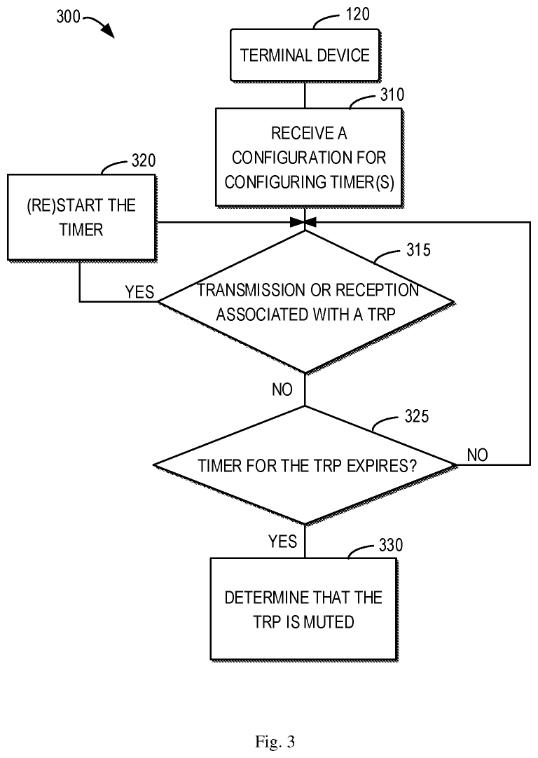

FIG. 3 illustrates another example of a process 300 for the enabling of the dynamic TRP adaptation according to an embodiment of the present disclosure. It is noted that the process 300 can be deemed as a more specific example of the process 200. It would be appreciated that the process 300 may be applied to the communication system 100 of FIG. 1 and any other similar communication scenarios.

As shown in FIG. 3, at block 310, the terminal device 120 may receive 310 a configuration for configuring one or more timers corresponding to one or more TRPs for the terminal device 120. At block 315, the terminal device 120 may determine whether one or more transmissions or receptions are performed with a TRP of the one or more TRPs for the terminal device 120.

The one or more transmissions or receptions may be predetermined transmissions or receptions. As discussed above, the one or more transmissions or receptions may comprise a reception of a PDSCH or a PDCCH from the TRP or a transmission of a UL channel or signal, or a MAC PDU to the TRP.

Based on, for example, receiving a PDSCH or PDCCH, or transmitting a PUSCH from/to the TRP, the terminal device 120, at block 320, may start or restart a timer corresponding to the TRP. Otherwise, at block 325, the terminal device 120 may determine whether the timer expires.

Based on determining that the timer expires, the terminal device 120 may determine 330 that the corresponding TRP is muted and perform acts accordingly for enabling of the dynamic TRP adaptation. As an example, the terminal device 120 may stop the timer. As another example, the terminal device 120 may flush the HARQ buffers corresponding to the muted TRP. As another example, the terminal device 120 may stop monitoring transmissions of some or all DL channels and signals from the unmuted TRP.

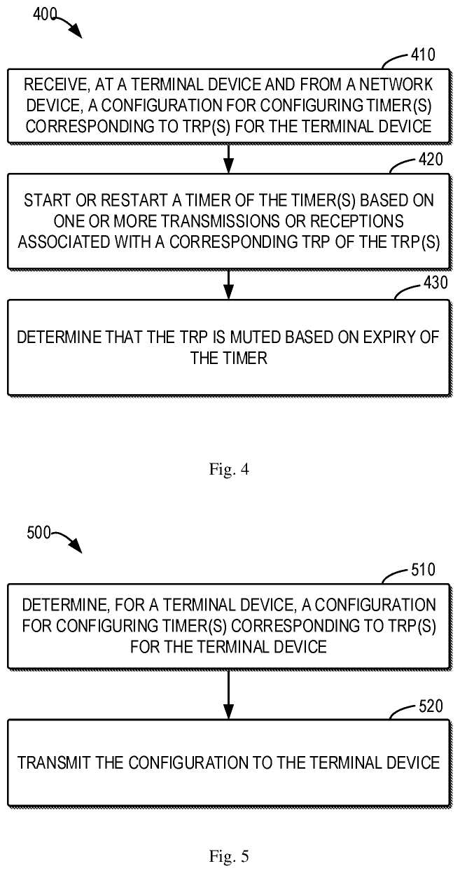

FIG. 4 shows a flowchart of an example method 400 implemented at a terminal device in accordance with some embodiments of the present disclosure. For the purpose of discussion, the method 400 will be described from the perspective of the terminal device 120 with reference to FIG. 1.

At block 410, the terminal device 120 receives, from the network device 111, a configuration for configuring one or more timers corresponding to one or more transmission reception points, TRPs, for the terminal device 120. At block 420, the terminal device 120 starts or restarts a timer of the one or more timers based on one or more transmissions or receptions associated with a corresponding TRP of the one or more TPRs. At block 430, the terminal device 120 determines that the TRP is muted based on expiry of the timer.

In some embodiments, the TRP is identified by an identifier comprising at least one of: an identity of a TRP, a set of reference signals, a CORESET Pool Index, or a physical cell index, PCI.

In some embodiments, the one or more transmissions or receptions associated with the TRP comprise at least one of: a reception of a physical downlink shared channel, PDSCH or a physical downlink control channel, PDCCH, transmitted from the TRP, wherein the PDCCH indicates an uplink, UL, grant or a downlink, DL, assignment, or a transmission of a UL channel or signal, or a MAC PDU to the TRP.

In some embodiments, the reception of the PDCCH is one of: a reception of a PDCCH sent on a control resource set, CORESET, belonging to a CORESET Pool Index corresponding to the TRP, or a reception of a PDCCH transmitted using a transmission configuration indicator, TCI, state that comprises quasi co-location, QCL, information related to a reference signal, RS, belonging to a subset of RSs corresponding to the TRP.

In some embodiments, the reception of the PDSCH is one of: a reception of a medium access control packet data unit, MAC PDU, transmitted using a semi-persistent scheduling, SPS, PDSCH activated by a PDCCH sent on a CORESET belonging to a CORESET Pool Index corresponding to the TRP, a reception of a MAC PDU transmitted using a SPS PDSCH related to a SPS configuration associated with a CORESET Pool Index or a PCI corresponding to the TRP, a reception of a MAC PDU transmitted using a SPS PDSCH transmitted using a TCI state that comprises QCL information related to an RS belonging to a subset of RSs corresponding to the TRP, or a reception of a PDSCH scheduled by a PDCCH sent on a CORESET belonging to a CORESET Pool Index corresponding to the TRP.

In some embodiments, the transmission of the UL channel or signal, or a MAC PDU to the TRP is one of: a transmission of a UL channel or signal, or a MAC PDU using a resource associated with a CORESET Pool Index or a PCI corresponding to the TRP, a transmission of a UL channel or signal using a TCI state that comprises QCL information related to an RS belonging to a subset of RSs corresponding to the TRP, or a transmission of a UL channel or signal scheduled by a PDCCH sent on a CORESET belonging to a CORESET Pool Index corresponding to the TRP. In some embodiments, the terminal device 120 may start or restart the timer further based on at least one of: an indication of unmuting the TRP from the network device 111, a radio resource control, RRC, reconfiguration, or a time period after the expiry of the timer.

In some embodiments, the terminal device 120 may further perform at least one of the following based on determining that the timer is muted: stopping the timer, stopping monitoring a predetermined transmission of a DL channel or signal from the TRP or stopping monitoring all transmissions of DL channels or signals from the TRP, stopping transmitting a predetermined UL channel or signal or stopping transmitting all UL channels and signals towards the TRP, flushing a hybrid automatic repeat request, HARQ, buffer corresponding to the TRP, or suspending or clearing one or more of a grant, a resource, or a configuration corresponding to the TRP.

In some embodiments, the one or more TRPs are configured in a serving cell or a group of serving cells for the terminal device 120. In some embodiments, the terminal device 120 may further send, to the network device 111, an indication indicating that the TRP is considered as being muted by the terminal device 120. In some embodiments, the one or more timers comprise multiple timers in a serving cell for the terminal device 120 and the terminal device 120 may further determine that the serving cell is muted based on expiry of the multiple timers. In some embodiments, the terminal device 120 may further perform at least one of the following based on determining that the TRP is muted: assuming that a synchronization signal block, SSB, is to be transmitted from the TRP, or measuring channel state information, CSI, corresponding to a CSI configuration.

FIG. 5 shows a flowchart of an example method 500 implemented at a network device in accordance with some embodiments of the present disclosure. For the purpose of discussion, the method 500 will be described from the perspective of the network device 111 with reference to FIG. 1.

At block 510, the network device 111 determines, for the terminal device 120, a configuration for configuring one or more timers corresponding to one or more transmission reception points, TRPs, for the terminal device 120, a timer of the one or more timers being configured to start or restart based on one or more transmissions or receptions associated with a corresponding TRP of the one or more TPRs, and expiry of the timer indicating that the TRP is muted. At block 520, the network device 111 transmits the configuration to the terminal device 120.

In some embodiments, the TRP is identified by an identifier comprising at least one of: an identity of a TRP, a set of reference signals, a CORESET Pool Index, or a physical cell index, PCI. In some embodiments, the one or more transmissions or receptions associated with the TRP comprise at least one of: a reception of a physical downlink shared channel, PDSCH or a physical downlink control channel, PDCCH, transmitted from the TRP, wherein the PDCCH indicates an uplink, UL, grant or a downlink, DL, assignment, or a transmission of a UL channel or signal, or a MAC PDU to the TRP.

In some embodiments, the reception of the PDCCH is one of: a reception of a PDCCH sent on a control resource set, CORESET, belonging to a CORESET Pool Index corresponding to the TRP, or a reception of a PDCCH transmitted using a transmission configuration indicator, TCI, state that comprises quasi co-location, QCL, information related to a reference signal, RS, belonging to a subset of RSs corresponding to the TRP.

In some embodiments, the reception of the PDSCH is one of: a reception of a medium access control packet data unit, MAC PDU, transmitted using a semi-persistent scheduling, SPS, PDSCH activated by a PDCCH sent on a CORESET belonging to a CORESET Pool Index corresponding to the TRP, a reception of a MAC PDU transmitted using a SPS PDSCH related to a SPS configuration associated with a CORESET Pool Index or a PCI corresponding to the TRP, a reception of a MAC PDU transmitted using a SPS PDSCH transmitted using a TCI state that comprises QCL information related to an RS belonging to a subset of RSs corresponding to the TRP, or a reception of a PDSCH scheduled by a PDCCH sent on a CORESET belonging to a CORESET Pool Index corresponding to the TRP.

In some embodiments, the transmission of the UL channel or signal, or a MAC PDU to the TRP is one of: a transmission of a UL channel or signal, or a MAC PDU using a resource associated with a CORESET Pool Index or a PCI corresponding to the TRP, a transmission of a UL channel or signal using a TCI state that comprises QCL information related to an RS belonging to a subset of RSs corresponding to the TRP, or a transmission of a UL channel or signal scheduled by a PDCCH sent on a CORESET belonging to a CORESET Pool Index corresponding to the TRP.

In some embodiments, the timer is configured to start or restart further based on at least one of: an indication of unmuting the TRP from the network device 111, a radio resource control, RRC, reconfiguration, or a time period after the expiry of the timer. In some embodiments, the one or more TRPs are configured in a serving cell or a group of serving cells for the terminal device 120. In some embodiments, the network device 111 may further receive, from the terminal device 120, an indication indicating that the TRP is considered as being muted by the terminal device 120.

In some embodiments, an apparatus capable of performing any of the method 400 (for example, the terminal device 120) may comprise means for performing the respective steps of the method 400. The means may be implemented in any suitable form. For example, the means may be implemented in a circuitry or software module.

In some embodiments, the apparatus comprises: means for receiving, from a network device, a configuration for configuring one or more timers corresponding to one or more transmission reception points, TRPs, for the terminal device; means for starting or restarting a timer of the one or more timers based on one or more transmissions or receptions associated with a corresponding TRP of the one or more TPRs; and means for determining that the TRP is muted based on expiry of the timer.

In some embodiments, the TRP is identified by an identifier comprising at least one of: an identity of a TRP, a set of reference signals, a CORESET Pool Index, or a physical cell index, PCI.

In some embodiments, the one or more transmissions or receptions associated with the TRP comprise at least one of: a reception of a physical downlink shared channel, PDSCH or a physical downlink control channel, PDCCH, transmitted from the TRP, wherein the PDCCH indicates an uplink, UL, grant or a downlink, DL, assignment, or a transmission of a UL channel or signal, or a MAC PDU to the TRP.

In some embodiments, the reception of the PDCCH is one of: a reception of a PDCCH sent on a control resource set, CORESET, belonging to a CORESET Pool Index corresponding to the TRP, or a reception of a PDCCH transmitted using a transmission configuration indicator, TCI, state that comprises quasi co-location, QCL, information related to a reference signal, RS, belonging to a subset of RSs corresponding to the TRP.

In some embodiments, the reception of the PDSCH is one of: a reception of a medium access control packet data unit, MAC PDU, transmitted using a semi-persistent scheduling, SPS, PDSCH activated by a PDCCH sent on a CORESET belonging to a CORESET Pool Index corresponding to the TRP, a reception of a MAC PDU transmitted using a SPS PDSCH related to a SPS configuration associated with a CORESET Pool Index or a PCI corresponding to the TRP, a reception of a MAC PDU transmitted using a SPS PDSCH transmitted using a TCI state that comprises QCL information related to an RS belonging to a subset of RSs corresponding to the TRP, or a reception of a PDSCH scheduled by a PDCCH sent on a CORESET belonging to a CORESET Pool Index corresponding to the TRP.

In some embodiments, the transmission of the UL channel or signal, or a MAC PDU to the TRP is one of: a transmission of a UL channel or signal, or a MAC PDU using a resource associated with a CORESET Pool Index or a PCI corresponding to the TRP, a transmission of a UL channel or signal using a TCI state that comprises QCL information related to an RS belonging to a subset of RSs corresponding to the TRP, or a transmission of a UL channel or signal scheduled by a PDCCH sent on a CORESET belonging to a CORESET Pool Index corresponding to the TRP. In some embodiments, the terminal device 120 may start or restart the timer further based on at least one of: an indication of unmuting the TRP from the network device 111, a radio resource control, RRC, reconfiguration, or a time period after the expiry of the timer.

In some embodiments, the one or more TRPs are configured in a serving cell or a group of serving cells for the terminal device 120.

In some embodiments, the means for starting or restarting a timer may comprise means for starting or restarting the timer further based on at least one of: an indication of unmuting the TRP from the network device, a radio resource control, RRC, reconfiguration, or a time period after the expiry of the timer.

In some embodiments, the apparatus may further comprise means for performing at least one of the following based on determining that the timer is muted: stopping the timer, stopping monitoring a predetermined transmission of a DL channel or signal from the TRP or stopping monitoring all transmissions of DL channels or signals from the TRP, stopping transmitting a predetermined UL channel or signal or stopping transmitting all UL channels and signals towards the TRP, flushing a hybrid automatic repeat request, HARQ, buffer corresponding to the TRP, or suspending or clearing one or more of a grant, a resource, or a configuration corresponding to the TRP.

In some embodiments, the apparatus may further comprise means for sending, to the network device, an indication indicating that the TRP is considered as being muted by the terminal device. In some embodiments, the one or more timers comprise multiple timers in a serving cell for the terminal device, and the apparatus may further comprise means for determining that the serving cell is muted based on expiry of the multiple timers.

In some embodiments, the apparatus may further comprise means for performing at least one of the following based on determining that the TRP is muted: assuming that a synchronization signal block, SSB, is to be transmitted from the TRP, or measuring channel state information, CSI, corresponding to a CSI configuration.

In some embodiments, the apparatus further comprises means for performing other steps in some embodiments of the method 400. In some embodiments, the means comprises at least one processor; and at least one memory including computer program code, the at least one memory and computer program code configured to, with the at least one processor, cause the performance of the apparatus.

In some embodiments, an apparatus capable of performing any of the method 500 (for example, the network device 111) may comprise means for performing the respective steps of the method 500. The means may be implemented in any suitable form. For example, the means may be implemented in a circuitry or software module.

In some embodiments, the apparatus comprises: means for determining, for a terminal device, a configuration for configuring one or more timers corresponding to one or more transmission reception points, TRPs, for the terminal device, a timer of the one or more timers being configured to start or restart based on one or more transmissions or receptions associated with a corresponding TRP of the one or more TPRs, and expiry of the timer indicating that the TRP is muted; and means for transmitting the configuration to the terminal device.

In some embodiments, the TRP is identified by an identifier comprising at least one of: an identity of a TRP, a set of reference signals, a CORESET Pool Index, or a physical cell index, PCI.

In some embodiments, the one or more transmissions or receptions associated with the TRP comprise at least one of: a reception of a physical downlink shared channel, PDSCH or a physical downlink control channel, PDCCH, transmitted from the TRP, wherein the PDCCH indicates an uplink, UL, grant or a downlink, DL, assignment, or a transmission of a UL channel or signal, or a MAC PDU to the TRP.

In some embodiments, the reception of the PDCCH is one of: a reception of a PDCCH sent on a control resource set, CORESET, belonging to a CORESET Pool Index corresponding to the TRP, or a reception of a PDCCH transmitted using a transmission configuration indicator, TCI, state that comprises quasi co-location, QCL, information related to a reference signal, RS, belonging to a subset of RSs corresponding to the TRP.

In some embodiments, the reception of the PDSCH is one of: a reception of a medium access control packet data unit, MAC PDU, transmitted using a semi-persistent scheduling, SPS, PDSCH activated by a PDCCH sent on a CORESET belonging to a CORESET Pool Index corresponding to the TRP, a reception of a MAC PDU transmitted using a SPS PDSCH related to a SPS configuration associated with a CORESET Pool Index or a PCI corresponding to the TRP, a reception of a MAC PDU transmitted using a SPS PDSCH transmitted using a TCI state that comprises QCL information related to an RS belonging to a subset of RSs corresponding to the TRP, or a reception of a PDSCH scheduled by a PDCCH sent on a CORESET belonging to a CORESET Pool Index corresponding to the TRP.

In some embodiments, the transmission of the UL channel or signal, or a MAC PDU to the TRP is one of: a transmission of a UL channel or signal, or a MAC PDU using a resource associated with a CORESET Pool Index or a PCI corresponding to the TRP, a transmission of a UL channel or signal using a TCI state that comprises QCL information related to an RS belonging to a subset of RSs corresponding to the TRP, or a transmission of a UL channel or signal scheduled by a PDCCH sent on a CORESET belonging to a CORESET Pool Index corresponding to the TRP. In some embodiments, the terminal device 120 may start or restart the timer further based on at least one of: an indication of unmuting the TRP from the network device 111, a radio resource control, RRC, reconfiguration, or a time period after the expiry of the timer.

In some embodiments, the one or more TRPs are configured in a serving cell or a group of serving cells for the terminal device 120.

In some embodiments, the apparatus may further comprise means for receiving, from the terminal device, an indication indicating that the TRP is considered as being muted by the terminal device.

In some embodiments, the apparatus further comprises means for performing other steps in some embodiments of the method 500. In some embodiments, the means comprises at least one processor; and at least one memory including computer program code, the at least one memory and computer program code configured to, with the at least one processor, cause the performance of the apparatus.

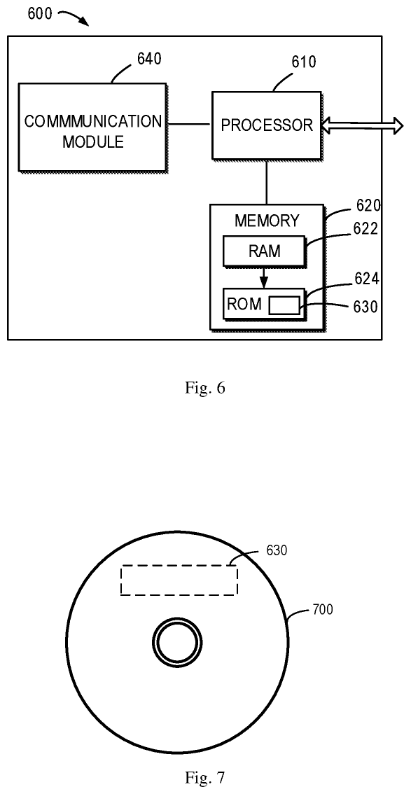

FIG. 6 is a simplified block diagram of a device 600 that is suitable for implementing embodiments of the present disclosure. The device 600 may be provided to implement the communication device, for example the terminal device 120, the network device 111 or the network device 112 as shown in FIG. 1. As shown, the device 600 includes one or more processors 610, one or more memories 640 coupled to the processor 610, and one or more communication modules 640 coupled to the processor 610.

The communication module 640 is for bidirectional communications. The communication module 640 has at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 624. The processor 610 may perform any suitable actions and processing by loading the program 630 into the RAM 622.

The embodiments of the present disclosure may be implemented by means of the program 630 so that the device 600 may perform any process of the disclosure as discussed with reference to FIGS. 2 to 5. The embodiments of the present disclosure may also be implemented by hardware or by a combination of software and hardware.

In some embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7 shows an example of the computer readable medium 700 in form of CD or DVD. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 400 or 500 as described above with reference to FIGS. 2-5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device comprising:
at least one processor; and
at least one memory storing instructions that, when executed by the at least one processor, cause the terminal device at least to:
receive, from a network device, a configuration for configuring one or more timers corresponding to one or more transmission reception points, TRPs, for the terminal device;
start or restart a timer of the one or more timers based on one or more transmissions or receptions associated with a corresponding TRP of the one or more TPRs; and
determine that the TRP is muted based on expiry of the timer.

2. The terminal device of claim 1, wherein the TRP is identified by an identifier comprising at least one of:
an identity of a TRP,
a set of reference signals,
a control resource set, CORESET, Pool Index, or
a physical cell index, PCI.

3. The terminal device of claim 1, wherein the one or more transmissions or receptions associated with the TRP comprise at least one of:
a reception of a physical downlink shared channel, PDSCH or a physical downlink control channel, PDCCH, transmitted from the TRP, wherein the PDCCH indicates an uplink, UL, grant or a downlink, DL, assignment, or
a transmission of a UL channel or signal, or a MAC PDU to the TRP.

4. The terminal device of claim 3, wherein the reception of the PDCCH is one of:
a reception of a PDCCH sent on a control resource set, CORESET, belonging to a CORESET Pool Index corresponding to the TRP, or
a reception of a PDCCH transmitted using a transmission configuration indicator, TCI, state that comprises quasi co-location, QCL, information related to a reference signal, RS, belonging to a subset of RSs corresponding to the TRP.

5. The terminal device of claim 3, wherein the reception of the PDSCH is one of:
a reception of a medium access control packet data unit, MAC PDU, transmitted using a semi-persistent scheduling, SPS, PDSCH activated by a PDCCH sent on a CORESET belonging to a CORESET Pool Index corresponding to the TRP,
a reception of a MAC PDU transmitted using a SPS PDSCH related to a SPS configuration associated with a CORESET Pool Index or a PCI corresponding to the TRP,
a reception of a MAC PDU transmitted using a SPS PDSCH transmitted using a TCI state that comprises QCL information related to an RS belonging to a subset of RSs corresponding to the TRP, or
a reception of a PDSCH scheduled by a PDCCH sent on a CORESET belonging to a CORESET Pool Index corresponding to the TRP.

6. The terminal device of claim 3, wherein the transmission of the UL channel or signal, or a MAC PDU to the TRP is one of:
a transmission of a UL channel or signal, or a MAC PDU using a resource associated with a CORESET Pool Index or a PCI corresponding to the TRP,
a transmission of a UL channel or signal using a TCI state that comprises QCL information related to an RS belonging to a subset of RSs corresponding to the TRP, or
a transmission of a UL channel or signal scheduled by a PDCCH sent on a CORESET belonging to a CORESET Pool Index corresponding to the TRP.

7. The terminal device claim 1, wherein the terminal device is caused to start or restart the timer further based on at least one of:
an indication of unmuting the TRP from the network device,
a radio resource control, RRC, reconfiguration, or
a timer period after the expiry of the timer.

8. The terminal device of claim 1, wherein the terminal device is further caused to perform at least one of the following based on determining that the timer is muted:
stopping the timer,
stopping monitoring a predetermined transmission of a DL channel or signal from the TRP or stopping monitoring all transmissions of DL channels or signals from the TRP,
stopping transmitting a predetermined UL channel or signal or stopping transmitting all UL channels and signals towards the TRP,
flushing a hybrid automatic repeat request, HARQ, buffer corresponding to the TRP, or
suspending or clearing one or more of a grant, a resource, or a configuration corresponding to the TRP.

9. The terminal device of claim 1, wherein the one or more TRPs are configured in a serving cell or a group of serving cells for the terminal device.

10. The terminal device of claim 1, wherein the terminal device is further caused to:
send, to the network device, an indication indicating that the TRP is considered as being muted by the terminal device.

11. The terminal device claim 1, wherein the one or more timers comprise multiple timers in a serving cell for the terminal device and wherein the terminal device is further caused to:
determine that the serving cell is muted based on expiry of the multiple timers.

12. The terminal device of claim 1, wherein the terminal device is further caused to perform at least one of the following based on determining that the TRP is muted:
assuming that a synchronization signal block, SSB, is to be transmitted from the TRP, or
measuring channel state information, CSI, corresponding to a CSI configuration.

13. The terminal device of claim 1, wherein the terminal device is further caused to perform at least one of the following based on determining that the TRP is muted:
assuming that a synchronization signal block, SSB, is not to be transmitted from the TRP, or
stopping measuring channel state information, CSI, corresponding to a CSI configuration.

14. A network device comprising:
at least one processor; and
at least one memory storing instructions that, when executed by the at least one processor, cause the network device at least to:
determine, for a terminal device, a configuration for configuring one or more timers corresponding to one or more transmission reception points, TRPs, for the terminal device, a timer of the one or more timers being configured to start or restart based on one or more transmissions or receptions associated with a corresponding TRP of the one or more TPRs, and expiry of the timer indicating that the TRP is muted; and
transmit the configuration to the terminal device.

15. (canceled)

16. The network device of claim 15, wherein the one or more transmissions or receptions associated with the TRP comprise at least one of:
a reception of a physical downlink shared channel, PDSCH or a physical downlink control channel, PDCCH, transmitted from the TRP, wherein the PDCCH indicates an uplink, UL, grant or a downlink, DL, assignment, or
a transmission of a UL channel or signal, or a MAC PDU to the TRP.

17. The network device of claim 16, wherein the reception of the PDCCH is one of:
a reception of a PDCCH sent on a control resource set, CORESET, belonging to a CORESET Pool Index corresponding to the TRP, or
a reception of a PDCCH transmitted using a transmission configuration indicator, TCI, state that comprises quasi co-location, QCL, information related to a reference signal, RS, belonging to a subset of RSs corresponding to the TRP.

18. The network device of claim 16 or 17, wherein the reception of the PDSCH is one of:
a reception of a medium access control packet data unit, MAC PDU, transmitted using a semi-persistent scheduling, SPS, PDSCH activated by a PDCCH sent on a CORESET belonging to a CORESET Pool Index corresponding to the TRP,
a reception of a MAC PDU transmitted using a SPS PDSCH related to a SPS configuration associated with a CORESET Pool Index or a PCI corresponding to the TRP,
a reception of a MAC PDU transmitted using a SPS PDSCH transmitted using a TCI state that comprises QCL information related to an RS belonging to a subset of RSs corresponding to the TRP, or
a reception of a PDSCH scheduled by a PDCCH sent on a CORESET belonging to a CORESET Pool Index corresponding to the TRP.

19. The network device of claim 18, wherein the transmission of the UL channel or signal, or a MAC PDU to the TRP is one of:
a transmission of a UL channel or signal, or a MAC PDU using a resource associated with a CORESET Pool Index or a PCI corresponding to the TRP,
a transmission of a UL channel or signal using a TCI state that comprises QCL information related to an RS belonging to a subset of RSs corresponding to the TRP, or
a transmission of a UL channel or signal scheduled by a PDCCH sent on a CORESET belonging to a CORESET Pool Index corresponding to the TRP.

20-21. (canceled)

22. The network device of claim 14, wherein the network device is further caused to:
receive, from the terminal device, an indication indicating that the TRP is considered as being muted by the terminal device.

23. A method comprising:
receiving, at a terminal device and from a network device, a configuration for configuring one or more timers corresponding to one or more transmission reception points, TRPs, for the terminal device;
starting or restarting, at the terminal device, a timer of the one or more timers based on one or more transmissions or receptions associated with a corresponding TRP of the one or more TPRs; and
determining, at the terminal device, that the TRP is muted based on expiry of the timer.

24-27. (canceled)
